(19) United States
(12) Patent Application Publication
(10) Pub. No.: US 2002/0182279 A1
(43) Pub. Date: Dec. 5, 2002

(54) Melt drip pelletization of polycarbonate oligomers and polymers

(76) Inventor: James Day, Scotia, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,754

(22) Filed: May 31, 2001

(51) Int. Cl. B28B 1/54; B32B 5/16

(52) U.S. Cl. 425/6; 428/402; 264/13

(57) ABSTRACT

The present invention discloses an apparatus and method for pelletizing polycarbonate oligomers and polymers. A heated pressurizable cylinder holds aggregate polycarbonate oligomers or polymers which becomes a melt. The bottom of the cylinder is connected to a distributor plenum having nozzles. A funneling device receives the polymer droplets that emerge from the plenum and channels them into a container that has a screen on the top that collects the product pellets. Finally, a blowing agent, such as phenol, can be added to the melt to impart small voids in the product pellets.

### BACKGROUND OF INVENTION

The present invention discloses an apparatus and method for converting polycarbonate oligomers and polymers into roughly spherical pellets. More particularly, the present invention provides a device and method for producing pellets that contain internal voids, which significantly increase the total surface area of the pellet formed thereby producing a pellet especially suited for use in solid state polymerization reactions. The voids are obtained by incorporating an appropriate blowing agent, such as phenol, into the polycarbonate undergoing pelletization.

Various devices and methods have been employed to produce pellets from viscous polymers. Traditional techniques often involve the formation of liquid portions or droplets, which are subsequently collected and solidified. For example, one known apparatus for the extrusion of a flowable mass (such as a molten polymer) onto a conveyor consists of inner and outer coaxial cylindrical containers. The inner container has a passage for dispensing the flowable mass. The outer container, which has a number of orifices, rotates around the inner cylinder. As it does so, the orifices on the outer cylinder align with the passageway on the inner container. With each alignment, the mass flows from the inner container, through the aligned orifices, and deposits on a conveyor to form what is referred to as pastilles.

Another known method involves a pastillation process for pelletizing ultra high melt flow (UHMF) crystalline polymers. A UHMF polymer may be, for example, a polyolefin homopolymer, a polyolefin copolymer, or a mixture thereof. Initially, molten polymer is transferred to a droplet-forming means. The droplet-forming means is generally an outer container, with orifices, which rotates around an inner container to allow a uniform amount of the polymer melt to emerge as droplets.

The droplets collect on a conveyor and cool for a time sufficient for solidification.

Polymer droplets have also been utilized in several other contexts. Free-flowing pellets of poly(ethylene terephthalate) oligomer have been made by quenching droplets of molten oligomer in water. Molten oligomer is fed to a droplet-forming means, which has a plate with multiple orifices. Under pressure, molten oligomer flows through the orifices and out into an inert gas. The molten oligomer dissociates into droplets at a distance from the plate under the force of surface tension. The molten droplets are then quenched in a tank of water. Finally, the oligomer pellets are slightly flattened to about 0.3 2.0 mm. in thickness and 0.8 4.0 mm. in circular diameter.

Another known method involves the utilization of a spray congealer, an apparatus that forms particles from low viscosity molten polymer. Molten polymer is conveyed to the rotating bowl of a centrifugal atomizing device. This device produces small spherical droplets that congeal in an inert gas in the form of spherical beads with an average particle size of 100 250 microns, depending on the rotation speed of the bowl.

In addition, polymers have been formed into solidified strands, ribbons, or sheets, which are subsequently broken into particles. For example, fracturing or granulation of a sheet may be achieved by various techniques, including ball milling. However, such methods may yield particles that are not uniform in shape and size. These processes also frequently generate an undesirable amount of fines, which render particle handling and processing difficult.

Any oligomer or polymer may be pelletized in accordance with the apparatus and method disclosed herein. The discussion that follows uses polycarbonate as a representative example. For example, high or low molecular weight linear bisphenol A polycarbonate or branched polycarbonate resin suitable for blow molding applications and having special properties such as high melt strength, high shear sensitivity and a high complex viscosity ratio are appropriate.

Traditionally, such polycarbonates are prepared by interfacial polycondensation or by melt phase carbonate interchange reaction. Branched polycarbonates are obtained when small amounts of polyhydric phenols as branching agent are included in the reaction mixture.

In an interfacial polycondensation process, a dihydroxyaromatic compound is reacted with phosgene in a mixed aqueous-organic solution along with an acid acceptor and a catalyst, usually an amine. The interfacial preparation of oligomeric chloroformates, which are subsequently converted to high molecular weight polycarbonate, is an alternative method.

Polyhydric phenols with three or more hydroxy group per molecule (i.e. 1,1,1-tris (4-hydroxyphenyl) ethane (THPE), and 1,3,5-tris-(4-hydroxyphenyl) benzene) have acted as branching agents for high melt strength blow moldable polycarbonate resins prepared by interfacial polycondensation. Numerous other branching agents, including cyanuric chloride, branched dihydric phenols, and 3,3-bis-(4-hydroxyphenyl)-oxyindoles, have also been used, as well as 1,2,3-trihydroxybenzene; 1,3,5-trihydroxybenzene; 1,3,5-tris(2-hydroxyethyl)cyanuric acid; 4,6-dimethyl-2,4,6-tris(4-hydroxyphenyl)heptane; 2,3,4-trihydroxyacetophenone; 2,3,4-trihydroxybenzophenone; 2,4,4″-trihydroxybenzophenone.

However, there are several disadvantages to the interfacial polycondensation process. Toxic and hazardous chemicals such as phosgene is utilized in these reactions. Further, the process employs a chlorinated hydrocarbon (i.e., methylene chloride), as an organic solvent which may require elaborate means to prevent the unintended escape of said solvent into the environment. Furthermore, the product polycarbonate contains residual sodium and chloride ions which negatively affect the product's hydrolytic stability.

Other methods to prepare linear and branched polycarbonates are known, such as through melt phase carbonate interchange reaction. In a typical melt phase process, a bisphenol is reacted with a diaryl carbonate in the melt along with a suitable catalyst to produce an oligomeric polycarbonate, usually with an weight average molecular weight in the range of 2,000-10,000 as determined by gel permeation chromatography, relative to polycarbonate or polystyrene standards. Then, the oligomer can be converted to a high molecular weight polycarbonate by increasing the polymerization temperature. Typically, branching agents which may be used in such melt phase processes include THPE, triphenyl trimellitate, triglycidyl isocyanurate, and 3,3-bis-(4-hydroxyphenyl)-oxyindoles.

The melt phase processes currently in use suffer from disadvantages. For instance, at very high conversions (>98%), the melt viscosity of the product polymer increases dramatically at high conversion, which makes handling the hot polymer melt difficult. The polymer's high viscosity increases the chance of poor mixing as well as generation of hot spots that can lead to loss of product quality. The melt-phase process also requires specially designed equipment, such as a Helicone mixer, operating at temperatures in the range of 270-350° C.

Recently, solid state polymerization (SSP) has been used to prepare high molecular weight polycarbonates. SSP utilizes substantially lower temperatures, in the range of 180-230° C., than those required in the melt process. This process does not require handling polymer melt at high temperatures and the equipment needed to perform the reaction is very simple. In a typical solid state polycondensation process, a suitable oligomer in the form of a pellet or a powder is subjected to programmed heating above the glass transition temperature of the polymer but below its sticking temperature with removal of volatile by-product such as phenol and diphenyl carbonate. The polycondensation reaction proceeds strictly in the solid state under these conditions.

The SSP process is typically performed in two steps. In the first step, a low melt viscosity linear oligomer is synthesized by the melt phase reaction of a bisphenol and a diaryl carbonate or by the interfacial process. Generally, a mixture of a bisphenol and a diaryl carbonate is heated to between 150° C. and 325° C. for between 4 to 10 hours with a transesterification catalyst to produce an oligomer having an weight average molecular weight of between 2,000-20,000 Daltons, and containing hydroxyl and carbonate end groups. This oligomer is referred to as the precursor polycarbonate. Thereafter, crystallization of the linear polycarbonate oligomer may be effectuated by: (a) dissolving the oligomer in a solvent and then evaporating the solvent in the presence of an appropriate catalyst; (b) suspending the oligomer in diluent and refluxing it for 0 to 10 hrs in presence of a suitable catalyst followed by evaporating the diluent; or (c) heating the oligomer at a temperature which is higher than the glass transition temperature but below its melting point in the presence of a suitable catalyst (thermal crystallization). The resulting crystalline polycarbonate exhibits superior properties relative to amorphous polycarbonates, including a relatively high melting point, thereby preventing fusion or sticking of the polycarbonate during solid state polymerization. Preferable solvents and diluants include aliphatic aromatic hydrocarbons, ethers, esters, ketones, and halogenated aliphatic and aromatic hydrocarbons. The resulting crystalline oligomer preferably has a crystallinity of between 5% and 55% as measured by a differential scanning calorimeter. Another crystallization technique requires the polycarbonate precursor to contact a non-solvent, such as an alcohol. This process reduces the formation of by-product fines, which are difficult to handle and polymerize. In some instances, alcohol mediated crystallization affords higher rates in both the crystallization and subsequent SSP steps, relative to thermal crystallization or solvent mediated crystallization.

The present invention relates to an apparatus and method for converting polycarbonate oligomers and polymers into roughly spherical pellets with internal voids. A melt drip pelletization system, involving a pressurized reservoir of molten polycarbonate, a heated distributor plenum, a turbulent bath, a pump, and a blowing agent, is described. While the resulting high surface area pellets of oligomeric polycarbonate may be utilized in any of the known polycarbonate preparation processes, they are particularly well-suited for efficient SSP. The resulting pellets avoid many of the problems associated with pelletization processes, including difficulties in flow, handling and durability.

### SUMMARY OF INVENTION

The present invention addresses the foregoing problems, and provides further surprising advantages and properties. These and further objects of the invention will be more readily appreciated when considering the following disclosure and appended claims.

In one aspect the present invention relates to an apparatus for forming melt drip pellets of polycarbonate oligomers or polymers. The apparatus comprises of a cylinder which is heated and pressurized; a plenum comprised of at least one nozzle; and a collection container for holding cooling liquid and collecting product pellets.

The present invention also relates to an apparatus and method for pelletizing polycarbonate oligomers and polymers to produce roughly spherical porous pellets which may be used advantageously in solid state polymerization. The method involves loading the polycarbonate oligomers or polymers in the cylinder and melting in the presence of a blowing agent. The melt is then distributed by the plenum through the nozzles to form molten droplets. Finally, the molten drops are cooled in liquid to form melt drip pellets. The attainment of pellets with relatively large surface areas is essential to newly emerging applications such as SSP. Finally, the invention also relates to the improved pellets produced by the disclosed apparatus and method. With greater surface areas and internal voids, the disclosed pellets exhibit significantly improved utility in SSP in comparison to previously available pellets.

### BRIEF DESCRIPTION OF DRAWINGS

The features and advantages of the present invention will become apparent from the following detailed description of the invention which when read with the accompanying FIGURE illustrate preferred embodiments of the invention.

FIG. 1 shows a front perspective view revealing the inner workings of a preferred embodiment of the current invention.

### DETAILED DESCRIPTION

The present invention may be understood more readily by reference to the following detailed description of preferred embodiments of the invention and the examples included herein. In this specification and in the claims which follow, reference will be made to a number of terms which shall be defined to have the following meanings.

The singular forms “a”, “an” and “the” include plural referents unless the context clearly dictates otherwise.

“Optional” or “optionally” mean that the subsequently described event or circumstance may or may not occur, and that the description includes instances where said event or circumstance occurs and instances where it does not.

As used herein the term “interfacial process” refers to a process comprising the simultaneous use of water and a water immiscible solvent.

The term “polycarbonate” as used herein includes copolycarbonates, homopolycarbonates and (co)polyester carbonates. Further, the term “polycarbonate” as used herein embraces both high and low molecular weight polycarbonates.

The term “high molecular weight polycarbonate” as used herein refers to polycarbonate having a weight average molecular weight of at least 25,000 Daltons.

The term “low molecular weight polycarbonate” as used herein refers to polycarbonate having a weight average molecular weight of than 20000 Daltons or less. The term “low molecular weight polycarbonate” and is used interchangeably with the terms “oligomeric polycarbonate” and “polycarbonate oligomers”.

As used herein the term “aromatic radical” refers to a radical having a valence of at least one comprising at least one aromatic group. Examples of aromatic radicals include phenyl, pyridyl, furanyl, thienyl, naphthyl, phenylene, biphenyl. The term includes groups containing both aromatic and aliphatic components, for example a benzyl group.

As used herein the term “aliphatic radical” refers to a radical having a valence of at least one comprising a linear or branched array of atoms which is not cyclic. The array may include heteroatoms such as nitrogen, sulfur and oxygen or may be composed exclusively of carbon and hydrogen. Examples of aliphatic radicals include methyl, methylene, ethyl, ethylene, hexyl, hexamethylene and the like.

As used herein the term “cycloaliphatic radical” refers to a radical having a valance of at least one comprising an array of atoms which is cyclic but which is not aromatic. The array may include heteroatoms such as nitrogen, sulfur and oxygen or may be composed exclusively of carbon and hydrogen. Examples of cycloaliphatic radicals include cyclopropyl, cyclopentyl cyclohexyl, tetrahydrofuranyl and the like.

As used herein the term “porous” refers to a polycarbonate precursor pellet which is substantially more porous than an otherwise identically prepared pellet formed in the absence of a blowing agent.

The present invention relates to an apparatus means and method for pelletizing polycarbonate oligomers and high molecular weight polycarbonate to provide porous, roughly spherical polycarbonate pellets advantageously used in solid state polymerization. These disclosures are especially valuable in the context of low viscosity and low molecular weight oligomers and polymers, since such substances are inherently difficult to pelletize due to their inability to be stranded in an extrusion process.

An exemplary process employs a melt drip pelletization system in a pressurizable cylinder which holds molten polycarbonate oligomers or high molecular weight polycarbonate under a nitrogen blanket. Heating elements surround the cylinder. Operating temperatures may vary from about 230° C. to about 295° C. The nitrogen blanket, which is maintained at a pressure of at least about 30 psi., prevents oxidation or discoloration in the melt and exerts a downward force on the melt. The bottom of the cylinder may be connected to a distributor plenum having, for example, at least 30 nozzles, preferably at least 50 nozzles, each of which has an opening diameter between about 0.01 and about 0.1 inches. In one embodiment of the present invention the plenum has between about 50 and about 60 nozzles each of which has an opening diameter between about 0.01 and about 0.1 inches. The plenum contains at least one heater cartridge. There is a control valve between the cylinder and the plenum that monitors the flow of polymer and thereby controls size of the pellets. A funneling device receives the polymer droplets that emerge from the plenum and channels them into a container. This container has a screen on the top that collects the product pellets. In addition, the container holds a turbulent bath of one of the following fluids: water, an acetone/water mixture, or a dimethyl carbonate (DMC)/methanol (MeOH) mixture. Turbulence in the fluid ensures cooling and rapid dispersion of the highly adhesive molten droplets as they rain down into the container. A recirculating pump and tube continuously transport the swirling liquid and pellets to the funneling device. The liquid and pellets then channel into the container, and the pellets are collected on the screen. The liquid falls back into the reservoir and is again circulated, along with the constant flow of droplets, by the pump. A blowing agent, such as phenol, is added to the melt to impart small voids in the product pellets. The resulting pellets have a greater porosity than corresponding melt drip pellets formed in the absence of a blowing agent.

In one aspect, the present invention is directed to the formation of porous, spherical pellets of polycarbonates comprising repeat units having structure I:

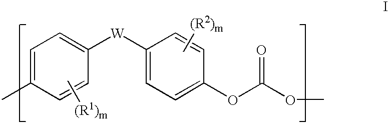

wherein R¹ and R² are independently fluorine, chlorine, bromine, aliphatic, cycloaliphatic or aromatic radicals, n and m are integers having values of 0 to 4, and W is an aliphatic radical, a cycloaliphatic radical an aromatic radical, or an oxygen, sulfur, SO or SO₂ linking group.

Polycarbonates comprising repeat units I are typically derived from bisphenols via melt or interfacial polycarbonate synthesis. Said bisphenols may be any of those known in the art to be useful for manufacturing polycarbonates. Examples of bisphenols suitable for incorporation into polycarbonates comprising repeat units having formula I include:bis(4-hydroxyphenyl)methane; 1,1-bis(4-hydroxyphenyl) ethane; 2,2-bis(4-hydroxyphenyl)propane (bisphenol-A); 2,2-bis(4-hydroxyphenyl) butane; 2,2-bis(4-hydroxyphenyl)octane; 2,2-bis(4-hydroxy-1-methylphenyl) propane; 1,1-bis(4-hydroxy-t-butylphenyl) propane; 2,2-bis(4-hydroxy-3-bromophenyl)propane; 1,1-bis(4-hydroxyphenyl)cyclopentane; 1,1-bis (4-hydroxyphenyl)cyclohexane; 4,4′-dihydroxydiphenyl ether;4,4′-dihydroxy-3,3′-dimethylphenyl ether; 4,4′-dihydroxydiphenyl sulfide;4,4′-dihydroxy-3,3′-dimethyldiphenyl sulfide; 4,4′-dihydroxydiphenyl sulfoxide; 4,4′-dihydroxy-3,3′-dimethyldiphenyl sulfoxide; 4,4′-dihydroxydiphenyl sulfone; and 4,4′-dihydroxy-3,3′-dimethyldiphenyl sulfone.

The most preferred polycarbonates are those derived entirely or in part from 2,2-bis(4-hydroxyphenyl)propane, also known as “bisphenol A”.

Precursor polycarbonates may be used in the disclosed method. Suitable precursors include polycarbonate oligomers of the type produced by the first step of a melt polycarbonate process or produced by bischloroformate oligomer preparation followed by hydrolysis and/or endcapping, and then isolation. Such oligomers typically have intrinsic viscosities in the range of about 0.06-0.30 dl/g, as determined in chloroform at 25° C. The precursor may alternatively be a branched polycarbonate. The precursor may be formed by reacting a bisphenol and a branching agent such as THPE with a source of carbonate units such as phosgene or diphenyl carbonate. The precursor polycarbonate may also be a copolycarbonate.

Further, the precursor polycarbonate may be a recycled polycarbonate (i.e., recycled compact disk polymers). These recycled polycarbonates, which are typically prepared by interfacial polymerization, melt polymerization, or from bischloroformates, may be utilized. These polycarbonates may also be created by first dissolving scrap polycarbonate in a chlorinated organic solvent (i.e., chloroform, methylene chloride or 1,2-dichloroethane), and then separating the non-polycarbonate constituents. Such recycled polycarbonates typically have molecular weights that are somewhat degraded from that of the originally polymerized material. That is, it has an intrinsic viscosity that is generally in the range of about 0.25-1.0 dl/g. In addition, other polycarbonates, such as interfacially prepared polycarbonates and polycarbonate extruder wastes, may be used as precursors.

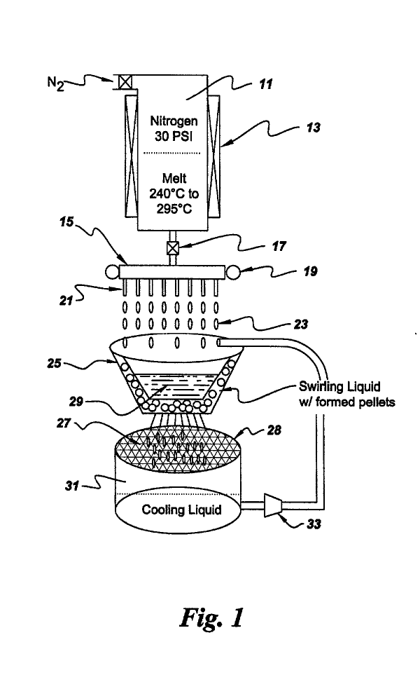

Referring first to FIG. 1, shown is a front perspective view revealing the inner workings of a preferred embodiment of the current invention. Shown is pressurized cylinder 11 surrounded by heating elements 13. Heating elements 13 heat cylinder 11 preferably to 230° C. to 295° C., thereby melting aggregate polycarbonate oligomers or polymers located under a nitrogen blanket contained within cylinder 11. The nitrogen blanket is maintained at a pressure of approximately thirty pounds per square inch to prevent oxidation of the oligomers or polymers, and to exert a downward force on the melt. Cylinder 11 feeds the oligomer or polymer melt through control valve 17 into distributor plenum 15.

Plenum 15 distributes molten droplets 23 of melt through nozzles 21. Preferably, Plenum 15 is comprised of fifty to sixty of such nozzles 21, each of which is between about 0.01 and about 0.1 inches in diameter. In one embodiment, nozzles 21 are about 0.19 inches in diameter. Plenum 15 is preferably heated by cartridges 19. Control valve 17 monitors the flow and size of molten droplets 23, which exit nozzles 21 and drop into cone-shaped funnel 25 containing cooling liquid 29. Cooling liquid 29 is continuously recirculated from collection container 31 by pump 33, and forms a turbulent cooling bath by circling around the inner walls of funnel 25. Upon contact with cooling liquid in funnel 25, molten droplets 23 form cooled pellets 27. In one embodiment, pellets 27 are spherical with a diameter of approximately two millimeters. Screen 28 on top of collection container 31 collects pellets 27 and allows cooling liquid 29 to return to collection container 31 for redistribution. The turbulent cooling bath in funnel 25 ensures efficient cooling and rapid dispersion of highly adhesive molten droplets 23 as molten droplets 23 drop onto screen 28 on collection container 31.

In a preferred embodiment, cooling liquid 29 is comprised of water, an acetone/water mixture, or a dimethyl carbonate/methanol mixture. In yet another preferred embodiment, a blowing agent (such as phenol) may be added to cylinder 11 to be dispersed in the melt and subsequently to impart voids in the final product, namely pellets 27.

Experimentally, it is observed that the spherical pellets are amorphous if water is used as the cooling liquid. Alternatively, if an acetone/water or a DMC/MeOH mixture is employed, the polycarbonate droplets form a crystalline shell upon contact with the liquid, the thickness of said shell depending upon the dimethyl carbonate fraction in the mixture. The presence of water and MeOH respectively in the two mixtures proportionally decreases the aggressiveness of weak solvents such as acetone and DMC, and facilitates dispersion of the pellets in the cooling bath.

The polycarbonate oligomers prepared by heating one or more bisphenols in the presence of diphenyl carbonate and a catalyst contain residual phenol, a mild blowing agent. In some instances the amount of residual phenol present in the polycarbonate oligomer is sufficient to provide porous polycarbonate pellets. The size of the internal voids is dependent upon the melt temperature. At melt temperatures between approximately 250° C. and 295° C. pellets possessing levels of porosity useful in solid state polymerization were obtained. Below 250° C., the pellets were rather solid in structure and insufficiently porous to for efficient use in solid state polymerization, and above 295° C., excessive foaming resulted due to the low melt strength and high vapor pressure of phenol. Polymers that not possessing a residual blowing agent can also be used. Under these circumstances, a compatible liquid, such as phenol or chlorobenzene, which possesses an appropriate boiling point can be added to the melt under pressure to generate voids in the product pellets prepared by the method of the present invention. These voids significantly increase the surface area of the pellets, which in turn significantly increases the utility of pellets in SSP processes.

The invention has been described in detail with particular reference to preferred embodiments thereof, but it will be understood by those skilled in the art that variations and modifications can be effected within the spirit and scope of the invention.

1. An apparatus for forming melt drip pellets of oligomers or polymers, said apparatus comprising:
a cylinder which is heated and pressurized;
a plenum comprised of at least one nozzle; and
a collection container for holding cooling liquid and collecting product pellets;
wherein said oligomers or polymers are loaded in said cylinder and melted in the presence of a blowing agent, and wherein said plenum distributes said melt through said nozzles to form molten droplets, and wherein said molten droplets are cooled in said liquid to form said melt drip pellets.

2. An apparatus according to claim 1, wherein said melt is kept pressurized under a nitrogen blanket.

3. An apparatus according to claim 1, wherein said cylinder is heated.

4. An apparatus according to claim 1, wherein said plenum is comprised of a plurality of nozzles.

5. An apparatus according to claim 1, wherein said nozzles have an opening diameter ranging from about 0.01 to 0.10 inches.

6. An apparatus according to claim 1, wherein said cooling liquid is selected from the group consisting of: water, an acetone/water mixture, and a dimethyl carbonate/methanol mixture.

7. An apparatus according to claim 1, wherein said blowing agent is phenol.

8. An apparatus for forming melt drip pellets of polycarbonate oligomers or polymers, said apparatus comprising:
a cylinder which is heated and pressurized;
a plenum comprised of at least one nozzle;
a funnel; and
a collection container for holding cooling liquid and collecting product pellets;
wherein said funnel contacts said molten droplets with said cooling liquid to form pellets, wherein said pellets drop through said funnel to said container and wherein said polycarbonate oligomers or polymers are loaded in said cylinder and melted in the presence of a blowing agent, and wherein said plenum distributes said melt through said nozzles to form molten droplets, and wherein said molten droplets are cooled in said liquid to form said melt drip pellets.

9. An apparatus according to claim 8, wherein said polycarbonate melt is kept pressurized under a nitrogen blanket and wherein said pressure is approximately 30 psi.

10. An apparatus according to claim 8, wherein said cylinder is heated to a temperature within the range of 230° C. to 295° C.

11. An apparatus according to claim 8, wherein said plenum is comprised of fifty to sixty nozzles.

12. An apparatus according to claim 8, wherein said nozzles have an opening diameter ranging from about 0.01 to 0.10 inches.

13. An apparatus according to claim 8, wherein said cooling liquid is selected from the group consisting of: water, an acetone/water mixture, and a dimethyl carbonate/methanol mixture.

14. An apparatus according to claim 8, wherein said cooling liquid is constantly redistributed to said funnel with a pump.

15. An apparatus according to claim 8, wherein said collection container is further comprised of a screen connected across the top of said collection container and wherein said screen collects said pellets and allows said cooling liquid to pass from said funnel to said container.

16. A method for forming melt drip pellets of oligomers or polymers, said method comprising the steps of:
melting said oligomers or polymers in the presence of a blowing agent to yield a melt;
forming molten droplets from said melt; and
cooling said droplets to yield said melt drip pellets.

17. A method according to claim 16, wherein said oligomers or polymers are kept pressurized under a nitrogen blanket.

18. A method according to claim 16, wherein said blowing agent is phenol.

19. A method according to claim 16, wherein said blowing agent is present in said oligomers or polymers.

20. A pellet prepared in accordance with the method of claim 16.

21. A pellet according to claim 20, said pellet having a spherical shape.

22. A pellet according to claim 20, said pellet having a diameter of approximately 2 millimeters.

23. A pellet according to claim 20, said pellet having internal voids.

24. A method for forming melt drip pellets of polycarbonate oligomers or polymers, said method comprising the steps of:
melting said polycarbonate oligomers or polymers in the presence of a blowing agent to yield a melt;
forming molten droplets from said melt; and
cooling said droplets to yield said melt drip pellets.

25. A method according to claim 13, wherein said polycarbonate oligomers or polymer are melted at a temperature in the range of 230° C. to 295° C.

26. A method according to claim 24, wherein said polycarbonate oligomers or polymers are kept pressurized under a nitrogen blanket to prevent oxidation of said polycarbonate oligomers or polymers and said melt.

27. A method according to claim 24, wherein said blowing agent is phenol.

28. A method according to claim 24, wherein said blowing agent is present in said polycarbonate oligomers or polymers.

29. A pellet prepared in accordance with the method of claim 24.

30. A pellet according to claim 28, said pellet having a spherical shape.

31. A pellet according to claim 28, said pellet having a diameter of approximately 2 millimeters.

32. A pellet according to claim 28, said pellet having internal voids.
